(19) United States
(12) Patent Application Publication
(10) Pub. No.: US 2008/0037163 A1
(43) Pub. Date: Feb. 14, 2008

(54) Clamp device

(75) Inventors: Toru Kohei, Kawasaki (JP); Keiji Aruga, Kawasaki (JP)

Correspondence Address: KRATZ, QUINTOS & HANSON, LLP, 1420 K Street, N.W., Suite 400, WASHINGTON, DC, 20005, US

(73) Assignee: FUJITSU LIMITED, Kawasaki (JP)

(21) Appl. No.: 11/647,189

(22) Filed: Dec. 29, 2006

(30) Foreign Application Priority Data
Aug. 11, 2006 (JP) 2006-220475

(51) Int. Cl. G11B 17/08

(52) U.S. Cl. 360/98.08

(57) ABSTRACT

A clamp device that clamps a disc onto a spindle motor that rotates the disc includes a clamp ring stacked on the disc and clamps the disc onto the spindle motor, a screw that fixes the clamp ring onto the spindle motor, and an axial force adjuster that nonlinearly changes a relationship between a tightening force of the screw and an axial force actually applied to the disc, and includes an elastic part that has a spring constant smaller than that of the clamp ring.

This application claims the right of a foreign priority based on Japanese Patent Application No. 2006-220475, filed on Aug. 11, 2006, which is hereby incorporated by reference herein in its entirety as if fully set forth herein.

### BACKGROUND OF THE INVENTION

The present invention relates generally to a storage, and more particularly to a clamp device for a recording medium in the storage. The present invention is suitable, for example, for a clamp device that clamps a disc onto a spindle hub in a hard disc drive (“HDD”).

Along with the recent spread of the Internet etc., a demand for fast recording of a large amount of information is growing. A magnetic disc drive, such as an HDD, is required to have a larger capacity and an improved response. For the larger capacity, the HDD narrows a track pitch on the disc and increases the number of installed discs. For the improved response, use of a higher speed spindle motor is promoted.

Plural discs are stacked around a spindle hub fixed onto a rotating shaft of the spindle motor, and capped by a clamp ring. The clamp ring clamps these discs when screwed onto the hub.

The high-density disc requires highly precise head positioning. It is thus necessary to restrain vibrations applied to and deformations of the discs, and to correct a weight imbalance (simply referred to as “imbalance” hereinafter) around the spindle motor axis. A primary factor of the imbalance is an imbalance between the disc and the spindle hub. A method of moving the disc to a balanced position is one known imbalance correcting method, and typically uses a balance corrector having impact application means for applying the impact to a housing that houses the disc and the spindle motor, as disclosed in Japanese Patent Applications, Publication Nos. 10-134502 and 11-39786.

In the balance correction using the balance corrector, the clamp ring tacks or provisionally fixes the discs. In tacking, the clamp ring must fix the disc at such an axial force (minimum value) that the impact applied by the impact application means does not destroy the spindle motor. On the other hand, the clamp ring must fix the discs at such an axial force (maximum value) that the disc does not shift in the rotation of the spindle motor and the impact applied by the impact application means can correct the imbalance. Thus, the axial force must be kept between the maximum value and the minimum value during tacking. The axial force is adjusted through a screw tightening force. Assume that the abscissa axis represents the screw tightening force, and the ordinate axis represents the axial force that is actually applied to the disc. Then, a small gradient of the proportionality or line between them facilitates the axial force adjustment. However, the clamp ring possesses a high gradient of the proportionality or line, and the axial force adjustment is difficult or requires a long time.

### BRIEF SUMMARY OF THE INVENTION

The present invention is directed to a clamp device and method, and a disc drive having the clamping device, which facilitate the axial force adjustment.

A clamp device according to one aspect of the present invention that clamps a disc onto a spindle motor that rotates the disc includes a clamp ring stacked on the disc and clamps the disc onto the spindle motor, a screw that fixes the clamp ring onto the spindle motor, and an axial force adjuster that nonlinearly changes a relationship between a tightening force of the screw and an axial force actually applied to the disc, and includes an elastic part that has a spring constant smaller than that of the clamp ring. This clamp device can form at least two types of gradients for the linear relationship (line) or proportionality between the tightening force and the axial force. In the first range, the elastic deformation of the elastic part of the axial force adjuster starts and ends. In the second range, the elastic deformation of the clamp ring of the axial force adjuster starts and ends. As a result, the first range can be assigned to the provisional fixation or tacking, and the second range can be assigned to the regular or final fixation.

For example, the axial force adjuster is provided between the clamp ring and the screw. Thereby, the axial force adjuster and the clamp ring are provided between the screw and the spindle motor, forming a superposition of two springs having different spring constants.

The axial force adjuster has one or more holes each of which the screw is inserted. When there are plural screw holes, it is not necessary to provide the axial force adjuster for each screw hole, and the number of components reduces. The axial force adjuster may have an annular section. The elastic member may be a base of the axial force adjuster, into which the screw is inserted. The axial force adjuster may be provided to the clamp ring, like a leg extending part of the clamp ring.

A storage having the above clamp device constitutes another aspect of the present invention.

A clamp method according to another aspect of the present invention that uses a clamp device to clamp a disc onto a spindle motor that rotates the disc includes the steps of provisionally fixing the disc using the clamp device by setting to a first proportionality a relationship between a tightening force of the screw and an axial force actually applied to the disc in correcting a rotational balance of the disc, and regularly fixing the disc using the clamp device by setting the relationship to a second proportionality that has a gradient greater than that of the first proportionality. This clamp method lessens the gradient of the proportionality for the provisional fixation, and facilitates the axial force adjustment.

Other objects and further features of the present invention will become readily apparent from the following description of the preferred embodiments with reference to accompanying drawings.

### BRIEF DESCRIPTION OF THE DRAWINGS

FIG. 1 is a perspective view showing an internal structure of a hard disc drive (“HDD”) according to one embodiment of the present invention.

FIG. 2 is a partial sectional and perspective view near the spindle motor shown in FIG. 1.

FIG. 3A is a schematic sectional view of a pre-screwed clamp ring and a spring member. FIG. 3B is a graph showing a relationship between the screw tightening force and the axial force in the clamp device.

FIG. 4A is a schematic plane view showing one illustrative spring member applicable to FIG. 3A. FIG. 4B is an exploded perspective view of the clamp device having the spring members shown in FIG. 4A. FIG. 4C is a partially enlarged perspective view of FIG. 4B.

FIG. 5A is a schematic plane view showing another illustrative spring member applicable to FIG. 3A. FIG. 5B is an exploded perspective view of the clamp device having the spring member shown in FIG. 5A. FIG. 5C is a partially enlarged perspective view of FIG. 5B.

FIG. 6A is an exploded perspective view of a clamp device having a clamp ring applicable to FIG. 3A. FIG. 6B is an enlarged perspective view of the clamp ring shown in FIG. 6A. FIG. 6C is an enlarged perspective view of the clamp ring shown in FIG. 6B viewed from its rear surface.

FIG. 7 is a schematic sectional view of a balance corrector.

FIG. 8 is a block diagram of a control system of the balance corrector shown in FIG. 7.

FIG. 9 is a flowchart for explaining a manufacturing method of the HDD shown in FIG. 1.

FIG. 10 is a schematic sectional view of the discs and the spindle motor that have imbalance.

FIG. 11 is a schematic sectional view of discs that lean to the same side.

FIG. 12 is a flowchart of a balance correcting method executed by a controller in the control system shown in FIG. 8.

FIG. 13 is a timing chart among a three-phase control signal of the spindle motor obtained by the controller in the control system shown in FIG. 8, a clock signal and an index signal.

FIG. 14 is a graph showing an output of an acceleration sensor shown in FIG. 7.

### DETAILED DESCRIPTION OF THE PREFERRED EMBODIMENTS

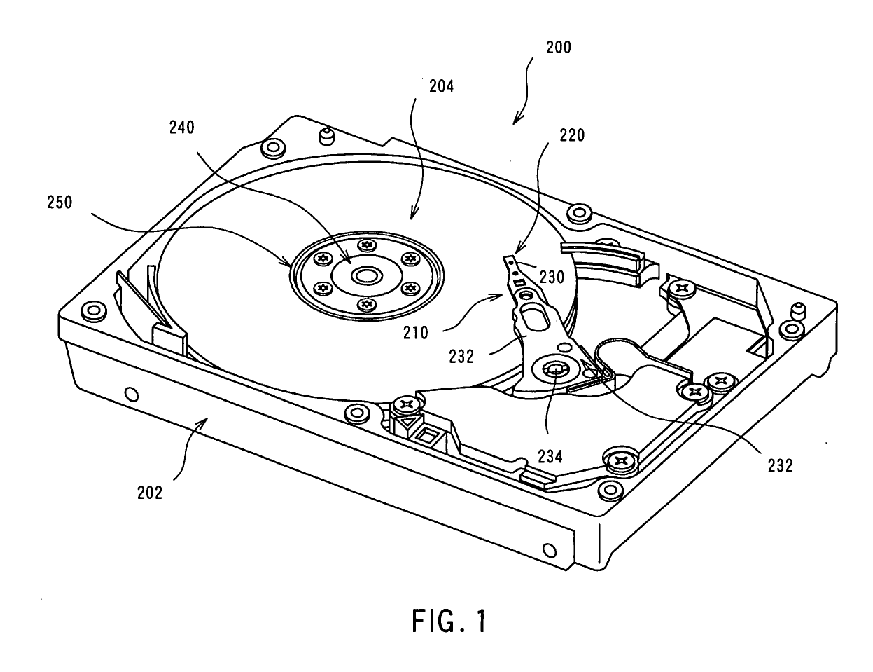

Referring now to the accompanying drawings, a description will be given of a HDD 200 according to one embodiment of the present invention. The HDD 200 includes, as shown in FIG. 1, plural magnetic discs 204 each serving as a recording medium, a head stack assembly (“HSA”) 110, a spindle motor 240, and clamp device 250 in a housing 202. Here, FIG. 1 is a schematic perspective view of the internal structure of the HDD 200.

The housing 202 is made, for example, of aluminum die cast base and stainless steel, and has a rectangular parallelepiped shape, to which a cover (not shown) that seals the internal space is jointed. The magnetic disc 204 of this embodiment has a high surface recording density, such as 200 Gb/in² or greater. The magnetic disc 204 is mounted on a spindle hub of the spindle motor 240 through its center hole.

The HSA 210 includes a magnetic head part 220, a suspension 230, and a carriage 232.

The magnetic head part 220 includes a slider, and an Al₂O₃ (alumna) head device built-in film that is jointed with an air outflow end of the slider and has a reading/recording head. The head embedded into the head device built-in film exposes from an air-bearing surface (“ABS”). The head of this embodiment is an MR inductive composite head that includes an inductive head device that writes binary information in the magnetic disc 204 utilizing a magnetic field generated by a conductive coil pattern (not shown), and a magnetoresistive (“MR”) head that reads the binary information based on the resistance that varies in accordance with the magnetic field applied by the magnetic disc 204.

The suspension 230 serves to support the magnetic head part 220 and to apply an elastic force to the magnetic head part 220 against the magnetic disc 204, and is, for example, a stainless steel Watlas-type suspension. This type of suspension has a flexure (also referred to as a gimbal spring or another name) which cantilevers the magnetic head part 220, and a load beam (also referred to as a load arm or another name) which is connected to the base plate. The suspension 230 also supports a wiring part that is connected to the magnetic head part 220 via a lead etc. Via this lead, the sense current flows and read/write information is transmitted between the head and the wiring part.

The carriage 232 swings around a shaft 234 by a voice coil motor (not shown) 141. The carriage 232 is also referred to as an “actuator,” an “E-block” due to its E-shaped section or “actuator (“AC”) block.” A support portion of the carriage is referred to as an “arm,” which is an aluminum rigid body that can rotate or swing around the shaft 234. The flexible printed circuit board (“FPC”) provides the wiring part with a control signal, a signal to be recorded in the disc 204, and the power, and receives a signal reproduced from the disc 204.

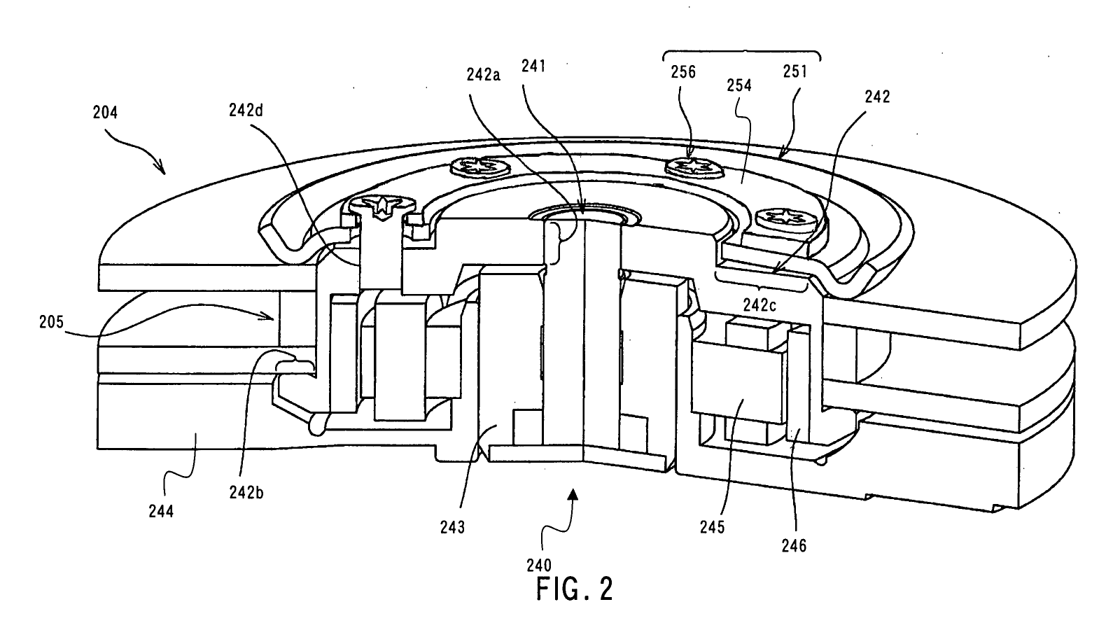

The spindle motor 240 rotates the magnetic disc 204 at such a high speed as 10,000 rpm, and has, as shown in FIG. 2, a shaft 241, a (spindle) hub 242, a sleeve 243, a bracket (base) 244, a core 245, and a magnet 246, and other members, such as an annular thrust plate, radial bearing, and lubricant oil (fluid). Here, FIG. 2 is a longitudinal sectional view of the spindle motor 240.

The shaft 241 rotates with the discs 204 and the hub 242.

The hub 242 is fixed onto the shaft 241 at its top 242a, and supports the disc 204 on its flange 242b. The hub 242 has an annular attachment surface 242c to which a clamp ring 251 of the clamp device 250 is attached. One or more (six in this embodiment) screw holes 242d are provided in the attachment surface 242c. While this embodiment provides six concentric screw holes 242d at regular intervals, the present invention does not limit the number of screw holes 242d to six, e.g., one, three, and four screw holes. When only one screw hole is provided, it is provided in the shaft 241 as the rotating center. Screws 256 of the clamp device 250 are engaged with these screw holes 242d.

The sleeve 243 is a member that allows the shaft 241 to be mounted rotatably. The sleeve 243 is fixed in the housing 202. While the shaft 241 rotates, the sleeve 243 does not rotate and forms a fixture part with the bracket 244. The sleeve 243 has a groove or aperture into which the lubricant oil is introduced. As the shaft 241 rotates, the lubricant oil generates the dynamic pressure (fluid pressure) along the groove. The bracket (base) 244 is fixed onto the housing 202 around the sleeve 243, and supports the core (coil) 245, the magnet 246, and a yoke (not shown). The current flows through the core 245, the magnet 246, and the yoke that serves as the hub constitute a magnetic circuit.

The clamp device 250 serves to clamp the discs 204 and the spacer 205 onto the spindle motor 240, and includes the clamp ring 251, a spring member (washer) 254, and the (clamp) screws 256.

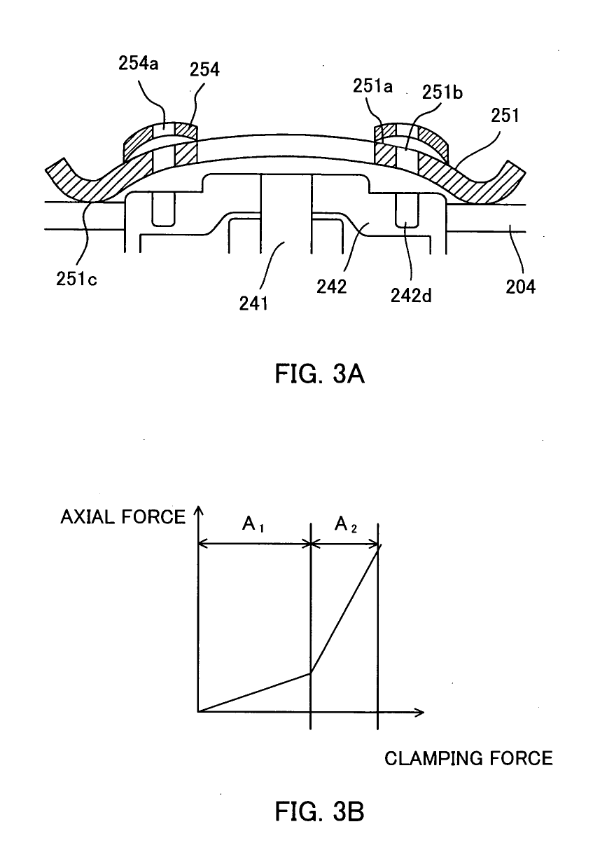

The clamp ring 251 is an annular disc member, and has a top surface 251a, plural screw holes 251b, which may not be tapped, and a pressure portion 251c. FIG. 3A is a schematic sectional view of the pre-screwed clamp ring 251. As shown in FIG. 3A, the pre-screwed clamp ring 251 has a bowl shape with a convex upward such that its inner side is located more distant from the top surface of the hub 242 than its outer side, when it is placed on the disc 204 and the spindle motor 240 so that it is fixed by the screws 256. This inclination is constant along the circumference of the clamp ring 251. The screwed clamp ring 251 follows the annular attachment surface 242c of the flat hub 242. In other words, the clamp ring 251 serves as a spring member having a spring constant.

Plural screw holes 251b are six concentric screw holes arranged at regular intervals in this embodiment. Similar to the screw holes 242d in the hub 242, the number of the screw holes 251b is not limited to six. The pressure portion 251c compresses and fixes the disc 204 onto the spindle motor 240.

In clamping the clamp ring 251 onto the hub 242 by the screws 256 and pressing the discs 204, the disc 204 may deform near the screws 256. A large amount of this distortion would cause unstable floating and positioning of the head, and lower the HDD's reliability. In order to reduce or eliminate this deformation, plural stress releasing holes may be formed concentrically among adjacent screw holes 251b.

The clamp ring 251 does not have a perforation hole through for the detection light from an optical sensor to pass. As described later, a controller 162 obtains a state signal or a three-phase signal from a spindle motor 240 directly, not indirectly from the optical sensor or mechanical index. As a result, the correction precision improves, and a balance corrector 100, which will be described later, can be made small and inexpensive.

The spring member 254 serves as an axial force adjuster that nonlinearly adjusts a relationship between the tightening force by the screw 256 and the axial force actually applied to the disc 204, as shown in FIG. 3B. As shown in FIG. 3A, the pre-screwed spring member 254 has a bowl shape with a convex upward such that its inner side is located more distant from the top surface of the hub 242 than its outer side, when it is placed on the top surface 251a of the clamp ring 251 so that it can be fixed by the screws 256. Similar to the clamp ring 251, the screwed spring member 254 becomes flat. In other words, the spring member 254 has a spring constant.

The spring constant of the spring member 254 is smaller than that of the clamp ring 251. Due to the spring members 254, the clamp device 250 can form two types of proportionality or lines between the tightening force (or screw rotating angle) and the axial force. An area A₁ is a region from when the elastic deformation of the spring member 254 starts to when the elastic deformation of the spring member 254 ends. An area A₂ is a region from when the elastic deformation of the clamp ring 251 starts to when the elastic deformation of the clamp ring 251 ends. As a result, the area A₁ can be assigned to provisional fixation or tacking, which will be described later, and the area A₂ can be assigned to final or regular fixation or adjustment.

As shown in FIG. 3A, the spring member 254 is provided between the clamp ring 251 and the screw 256's head (not shown). Thereby, the spring member 254 and the clamp ring 251 are arranged between the screw 256's head and the spindle motor 240, forming a superposition of a pair of springs having different spring constants.

The spring member 254 has one or more holes 254a into each of which the screw 256 is inserted. When it has plural screw holes 254a, the number of components reduces because a different spring member 254 is not needed for each screw hole 254a.

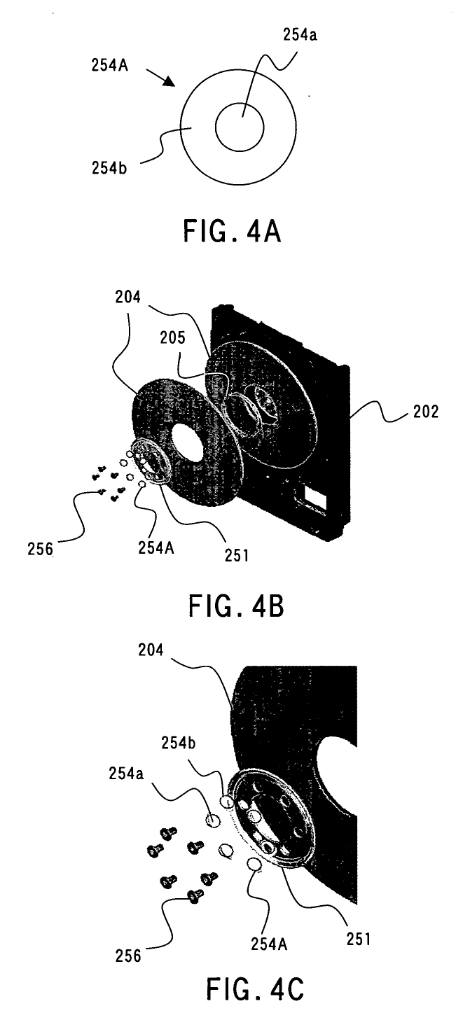

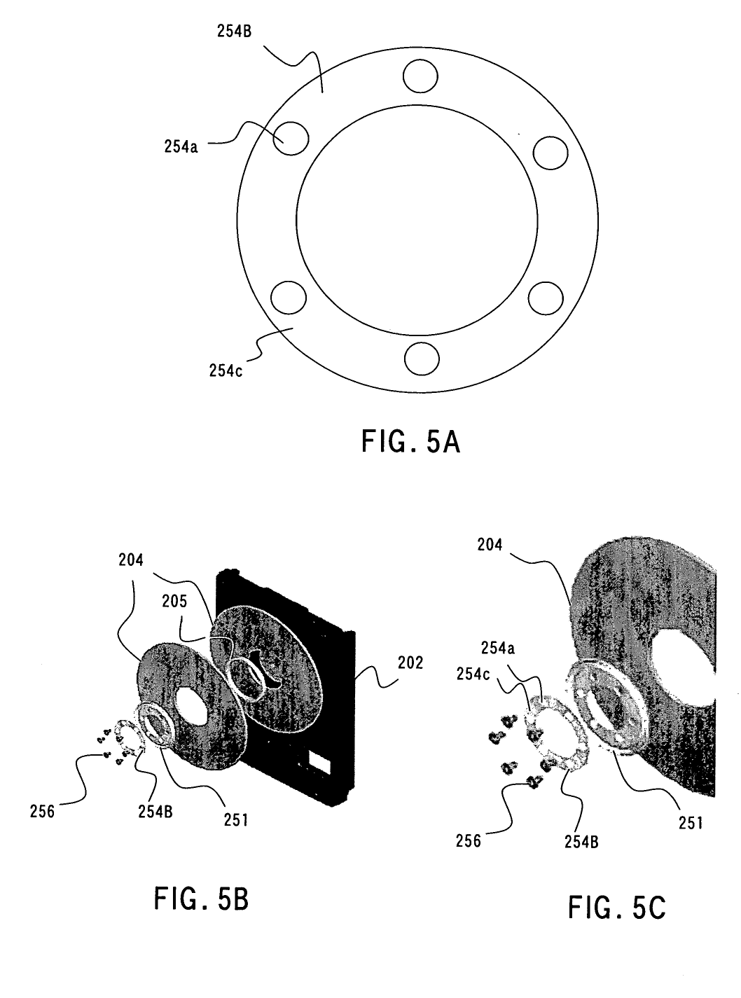

FIG. 4A is a schematic plane view of a spring member 254A having one screw hole 254a. FIG. 4B is an exploded perspective view of the clamp device 250 mounted with six spring members 254A shown in FIG. 4A. FIG. 4C is a partially enlarged perspective view of FIG. 4B. FIG. 5A is a schematic plane view of a spring member 254B having six spring holes 254a. FIG. 5B is an exploded perspective view of the clamp device 250 having the spring member 254B. FIG. 5C is a partially enlarged perspective view of FIG. 5B. FIG. 2 shows the spring member 254B.

When the spring member 254 uses the spring member 254A, the spring member 254A is provided for each screw hole 251b. In other words, six spring members 254A are provided. On the other hand, when the spring member 254 uses the spring member 254B, only one spring member 254B is used because it has six screw holes 254a.

Both the spring members 254A and 254B have an annular shape, but the center hole of the spring member 254A is the spring hole 254a whereas the center hole of the spring member 254B is a hole through which the hub 242 projects. Both the spring members 254A and 254B have elastic parts at bases 254b and 254c in which the screw holes 251a are formed. However, the spring member 254 is not limited to a type that has an elastic part at the base.

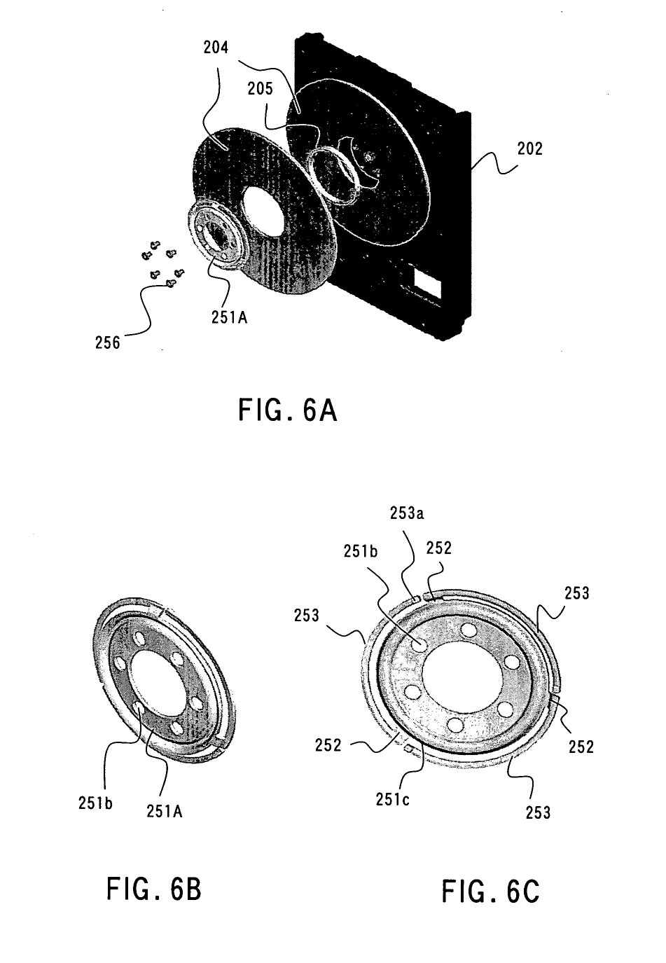

FIG. 6A is an exploded perspective view of a clamp ring 251A as a variation of the clamp ring 251. FIG. 6B is an enlarged perspective view of the clamp ring 251A. FIG. 6C is an enlarged perspective view of the clamp ring 251A at its rear surface side. The clamp ring 251A has a shape similar to the clamp ring 251, and possesses three arc-shaped legs 253 each connected to a connection part 252 having a predetermined width and arranged at intervals of 120° around the circumference of the clamp ring 251. A diameter of the clamp ring 251A is the same as, but not limited to, that of the clamp ring 251.

Each leg 253 has the same shape. Each leg 253 is connected to the connection part 252 at its one end, and extends with a predetermined width clockwise around the circumferential direction of the clamp ring 251A. The legs 253 may extend counterclockwise. An arc of each leg 253 has a center angle of 120° , and inclines by a predetermined angle at the disc 204 side from the one end to the disc 204 along the longitudinal direction (or circumferential direction). Each leg 253 contacts the disc 204 at the other end 253a. Each leg 253 serves as an elastic part that elastically deforms until it becomes flat on the disc 204. While this embodiment symmetrically arranges these three legs 253 and three connection parts 252 at regular intervals of 120°, two legs and two connection parts may be arranged at regular intervals of 180° or n legs and n connection parts may be arranged at regular intervals of (360/n)°.

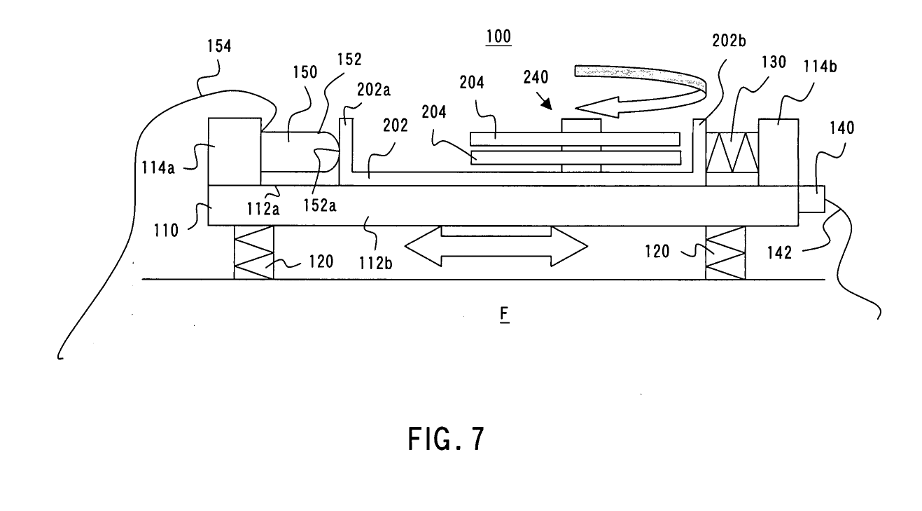

Referring now to FIG. 7, a balance corrector 100 will be described. Here, FIG. 7 is a schematic sectional view of the balance corrector 100. The balance corrector 100 detects and corrects imbalance so that the imbalance amount falls within a permissible range. The imbalance is recognized as a vibration of a housing (or disc enclosure base) 202 when a pair of discs 204 are rotated with the spindle hub 242 of the spindle motor 240 in the pre-assembled HDD 200. Therefore, the balance corrector 100 detects and corrects the vibration of the housing 202. While this embodiment provides two discs 204, the number of discs 204 is not limited to two.

The balance corrector 100 includes, as shown in FIG. 7, a plate 110, plural spring members 120, a compression spring 130, an acceleration sensor (detector) 140, a piezoelectric actuator 150, and a controller 160 (not shown in FIG. 7). The housing 202 may be part of the housing 202 shown in FIG. 1.

The plate 110 is a box member made of a material, such as aluminum and stainless steel, and supports the housing 202. The plate 110 has a rectangular bottom surface, and has sidewalls 114a and 114b around a front surface 112a. FIG. 7 shows only the left sidewall 114a and the right sidewall 114b. A bearing and rubber may be inserted between the surface 112a of the plate 110 and the housing 202. The plate 110 supports the piezoelectric actuator 150 (impact applicator) and the housing 202.

The spring member 120 serves to prevent attenuation of the vibration when the spindle motor 240 is driven, and supports the plate 110. The spring members 120 enable the plate 110 to integrally vibrate with the housing 202, preventing the reduction of the vibration when the spindle motor 240 rotates.

Four spring members 120 are connected to both the floor F and four points of the bottom surface 112b of the plate 110 symmetrically. The rectangle made by connecting centers of four spring members 120 is similar to the bottom rectangular of the plate 110. The center (or center of gravity) of the rectangle made by connecting centers of four spring members 120 approximately accords with the center of gravity of the plate 110 and the components mounted on the plate 110. Of course, the number of spring members 120 is not limited.

The spring member 120 has a spring constant k that satisfies the following Equation 1, where m is a total weight supported by or above the spring member 120, ωo is a rotating frequency of the spindle motor 240, and ωp is a resonance frequency of the housing 202 and plate 110.

ωo≦ωp=√k/m [EQUATION 1]

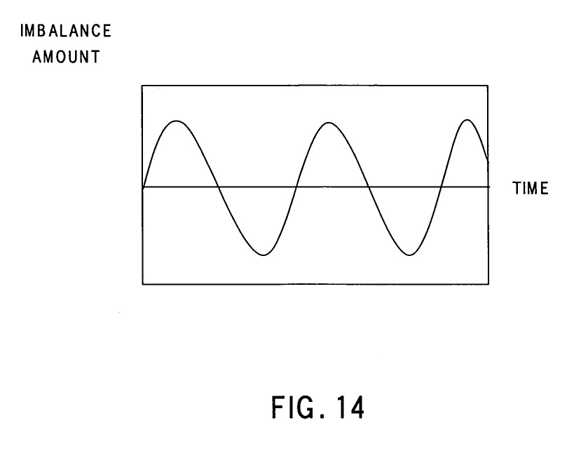

Equation 1 can prevent a reduction of the vibration of the spindle motor 240. If ωo=ωp is met, the amplitude of the waveform shown in FIG. 14, which will be described later, becomes excessively large due to the resonance. Thus, the following equation is preferably met:

ωo<ωp [EQUATION 2]

In the range that satisfies Equation 2, the vibration of the spindle motor 240 does not reduce and the amplitude of the waveform shown in FIG. 14, which will be described later, becomes constant. For plural spring members 120, k is a combined spring constant, and satisfies the following Equation 3, where k₁ is a spring constant of the first spring member 120, k₂ is a spring constant of the second spring member 120, k₃ is a spring constant of the second spring member 120, . . . .

$$\frac{1}{k} = \frac{1}{{k}_{1}} + \frac{1}{{k}_{2}} + \frac{1}{{k}_{3}} + Λ \qquad [ EQUATION 3 ]$$

One end of the compression spring 130 is engaged with the sidewall 114b, and the other end of the compression spring 130 is engaged with the outer side of the right side surface 202b of the housing 202. The compression spring 130 applies a force to the housing 202 against the piezoelectric actuator 150. The spring constant of the compression spring 130 is not limited, but is stronger than the spring constant of the spring member 120.

The acceleration sensor 140 detects the vibration of the housing 202 and the plate 110 when the spindle motor 240 is driven. The acceleration sensor 140 is mounted on the plate 110, and spaced from the housing 202. Therefore, the acceleration sensor 140 is not affected by the impact applied by the piezoelectric actuator 150 to the housing 202. The detection precision of the acceleration sensor 140 is not affected by the attachment and detachment of the housing 202. In addition, in the attachment and detachment of the housing 202, the attachment and detachment of the acceleration sensor 140 are not necessary, improving the operability. The spring members 120 maintain such an sufficiently high output of the acceleration sensor 140 that it is less influential to noises, improving the measurement precision.

The piezoelectric actuator (or hammer) 150 uses a piezoelectric element and point-contacts the side surface 202a of the housing 202. The piezoelectric actuator 150 is an impact applicator that corrects the imbalance by applying the impact to the housing 202. The point contact of the piezoelectric actuator 150 with the housing 202 eliminates an alignment that would be otherwise required for Japanese Patent Applications, Publication Nos. 10-134502 and 11-39786 in which they surface-contact each other, thereby improving the operability. In FIG. 7, the piezoelectric actuator 150 has a semispherical tip 152 that has a vertex 152a for contact with the housing 202. The piezoelectric actuator 150 can stably apply a predetermined impact force to the housing 202, improving the balance correction-precision. While this embodiment provides the semispherical tip 152 to the piezoelectric actuator 150, a semispherical cap may be attached to a cylindrical piezoelectric actuator 150.

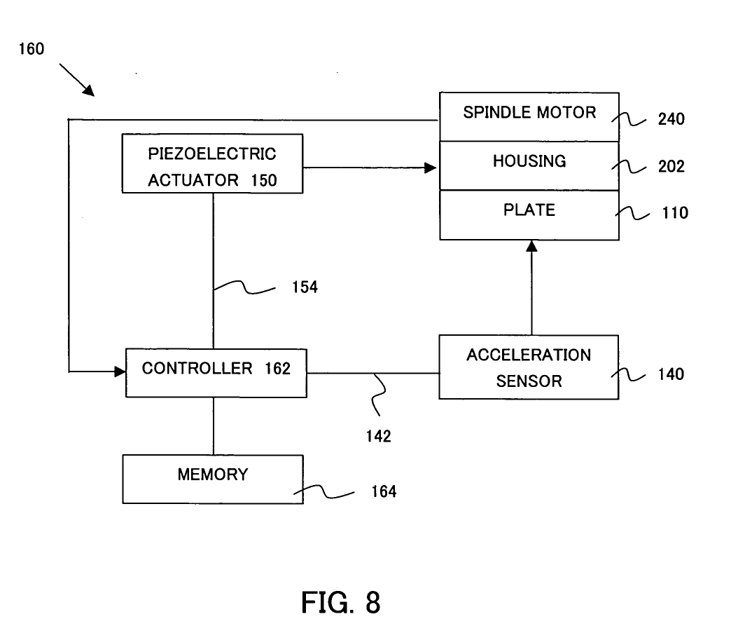

The control system 160 includes, as shown in FIG. 8, a controller 162, and a memory 164. The controller 162 is connected to the spindle motor 240 and the memory 164. The controller 162 is connected to the acceleration sensor 140 via a signal line 142, and connected to the piezoelectric actuator 150 via a signal line 154. The controller 162 controls each component in the balance corrector 100, and executes the balance correcting method, which will be described later. The memory 164 includes a ROM and a RAM, and stores the balance correcting method, which will be described later, and the permissible balance amount of the disc 204.

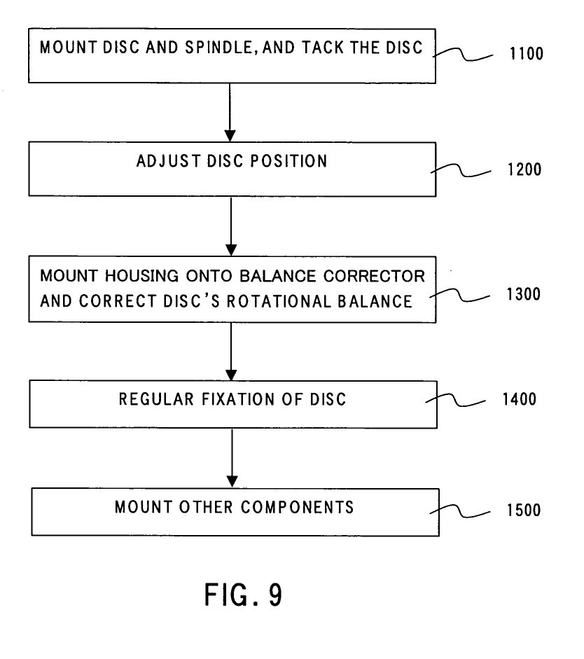

Referring now to FIG. 9, a description will be given of a manufacturing method of the HDD 200. First, the spindle motor 240 and a pair of discs 204 are mounted on the housing 202, and discs 204 are tacked or provisionally fixed (step 1100). More specifically, the spindle motor 240 is attached to the housing 202, and then a pair of discs 204 are attached to the spindle motor 240.

In the provisional fixation, the clamp ring 251 fixes the discs 204 at such an axial force that the impact applied by the piezoelectric actuator 150 does not destroy the spindle motor 240. On the other hand, the clamp ring 251 fixes the discs 204 at such an axial force that the discs 204 do not shift in the rotation of the spindle motor 240 and the impact applied by the piezoelectric actuator 150 can correct the imbalance.

For easy axial force adjustment in the provisional fixation, this embodiment assigns the area A₁ shown in FIG. 3B to the provisional fixation and the area A₂ to the regular or final fixation. Without the spring member 254, only the area A₂ of the clamp ring 251 exists. The sharp gradient narrows a range of the screw tightening force to the permissible axial force range. On the other hand, when the spring constant of the clamp ring 251 is made small so that only the area A₁ exists, the anti-shock property of the HDD 200 lowers due to the insufficient axial force. In the area A₁, a lessened gradient allows a wide range of the screw tightening force corresponding to the permissible axial force range, and facilitates the provisional fixation.

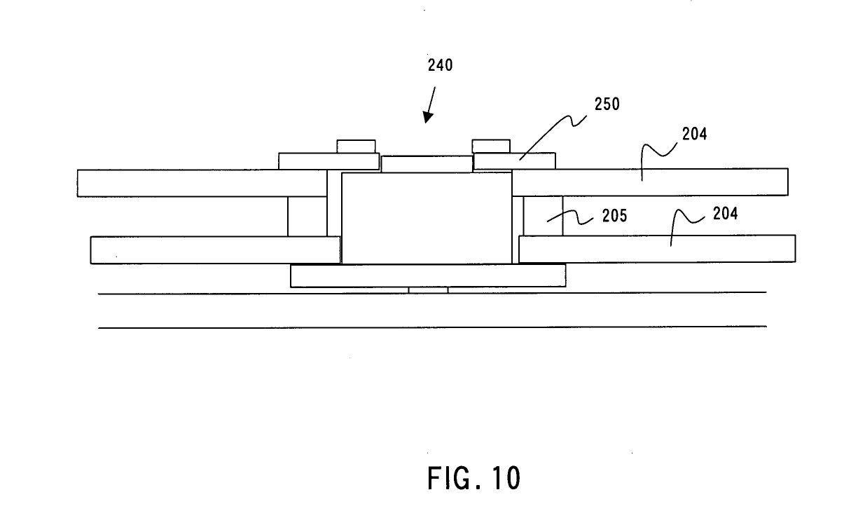

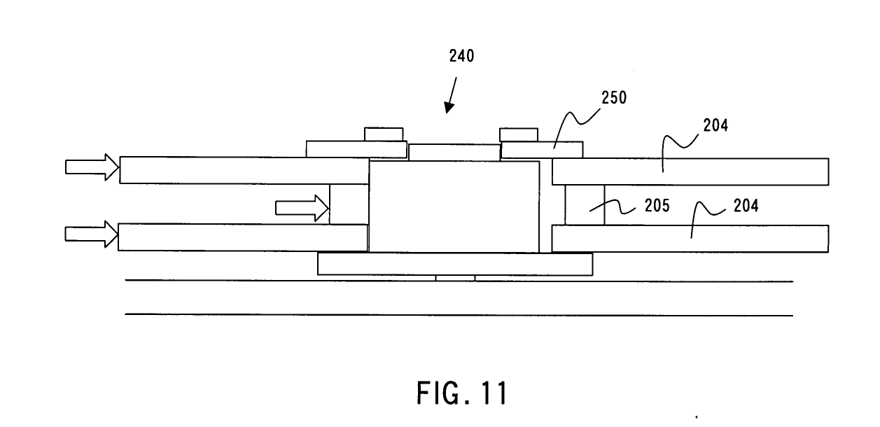

Next, a position of the disc 204 is adjusted (step 1200). This embodiment leans the discs 204 to the same side of the hub 242 of the spindle motor 240. According to the experiments by the instant inventors, the balance corrector 100 has a difficulty in moving the discs 204 due to a difference of a frictional force between the discs 204 when the plural discs 204 are alternately arranged as shown in FIG. 10. On the other hand, when all discs 204 are aligned with the same direction or lean to the same side, as shown in FIG. 11, a difference of a frictional force is 0 among the discs 204, and the adjustment by the balance corrector 100 becomes easier.

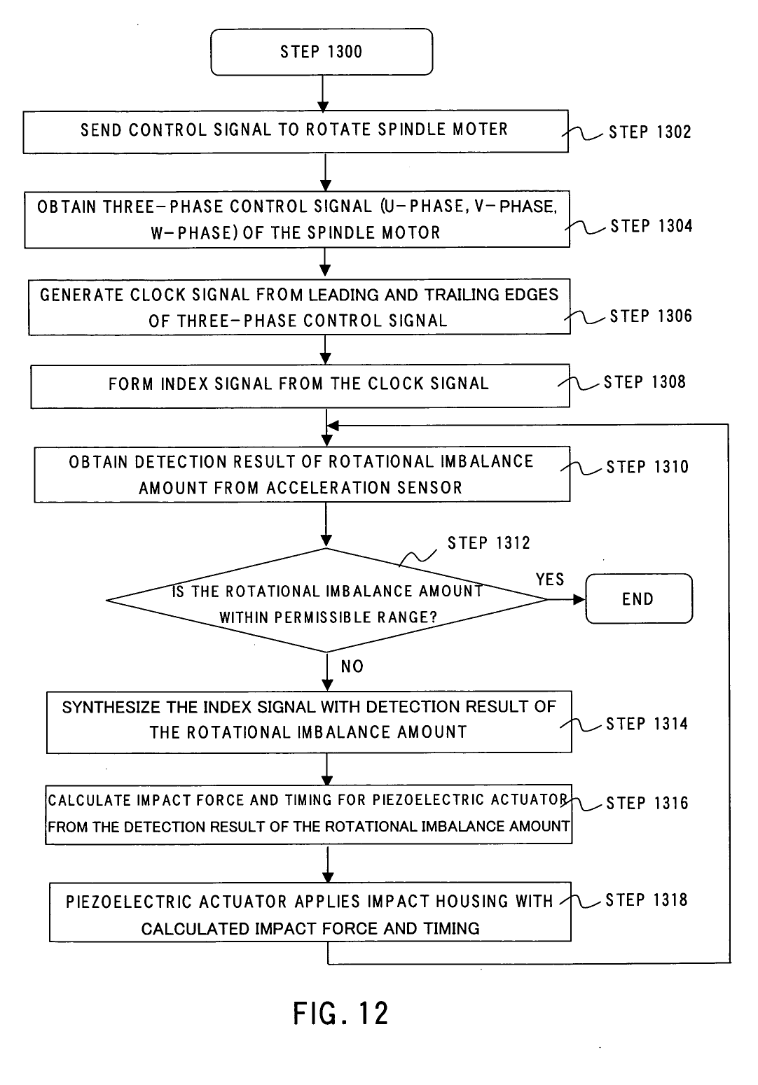

Next, the housing 202 is mounted onto the balance corrector 100, and the rotational balance of the discs 204 is corrected (step 1300). Referring now to FIG. 12, a description will be given of the balance correcting method executed by the controller 162. Here, FIG. 12 is a flowchart of the balance correcting method.

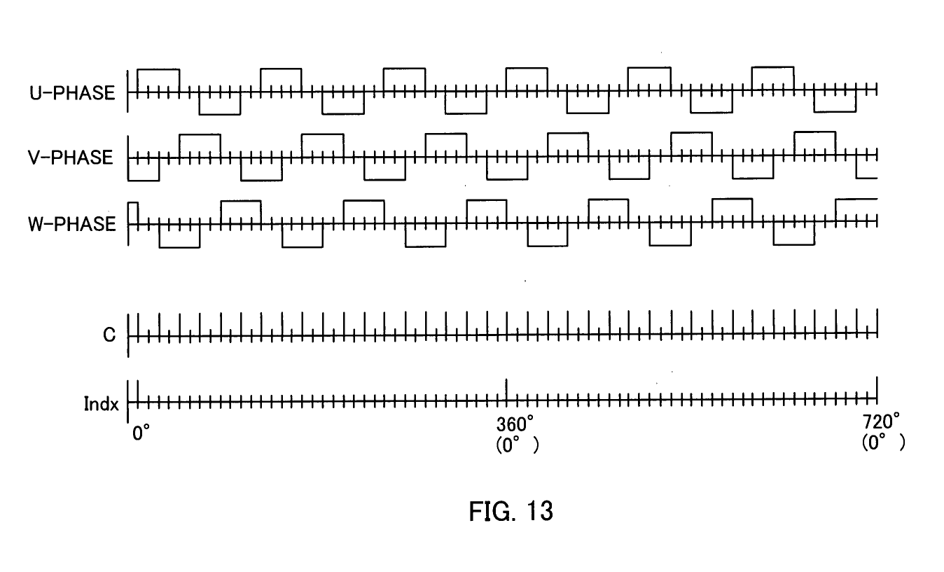

First, the controller 162 sends a control signal to the spindle motor 240 to rotate it in the state of FIG. 7 (step 1302). As a result, the spindle motor 240 rotates with the discs 204 in the arrow direction shown in FIG. 7. The spindle motor 240 of this embodiment is a three-phase nine-pole motor. When the controller 162 sends a rotating command to the spindle motor 240, the spindle motor 240, in response, sends a three-phase signal (U-phase, V-phase, W-phase) to the controller 162 (step 1304). FIG. 13 shows each signal. Next, the controller 162 generates a clock signal C from the leading and trailing edges of the three-phase signal (step 1306). FIG. 13 also shows the clock signal C that corresponds to at least one of the leading and tailing edges of the three-phase signal.

Next, the controller 162 forms an index signal Indx (rotating phase difference information) from the clock signal (step 1308). FIG. 13 also shows the index signal Indx. It is known that which clock corresponds to 360° from the structure of the spindle motor 240, i.e., three-phase nine-pole motor.

Next, the controller 162 obtains a detection result of the imbalance amount from the acceleration sensor 140 (step 1310). FIG. 14 shows a detection result of the imbalance amount, in which the ordinate axis represents the imbalance amount (acceleration), and the abscissa axis represents the time.

Next, the controller 162 determines whether the imbalance amount of the discs 204 detected by the acceleration sensor 140 falls within the permissible range stored in the memory 164 (step 1312). When the controller 162 determines that the imbalance amount falls within the permissible range (step 1312), the controller 162 ends the process. The permissible range is a predetermined range in which the amplitude of the vibration waveform is close to 0.

On the other hand, when the controller 162 determines that the imbalance amount is outside the permissible range (step 1312), the controller 162 detects the shift amount of the waveform in the abscissa axis direction in FIG. 14 from the index signal Indx (step 1314). As a result, the rotating angle of the spindle motor 240 at the peak value of the sine curve is detected.

Next, the controller 162 calculates the impact force and impact application timing by the piezoelectric actuator 150 from the detection result of the imbalance amount shown in FIG. 14 (step 1316). In other words, the controller 162 obtains a value that inverts the peak value from FIG. 14, and the timing for it (or a corresponding clock) from FIG. 13. Next, the controller 162 controls the piezoelectric actuator 150, and applies the impact to the housing 202 at the calculated impact force and timing (step 1318). The impact is applied in the arrow direction in FIG. 7. Thereafter, the flow returns to the step 1310.

Turning back to FIG. 9, the clamp ring 251 is finally or regularly fixed in the balance-corrected housing 202 so as to tightly fix the discs 204 (step 1400). In the regular fixation, the clamp ring 251 fixes the discs 204 at such an axial force that the impact applied by the piezoelectric actuator 150 cannot shift the discs 204 or the impact guaranteed by the HDD 200 can be maintained. The regular fixation uses the area A₂, as described above, and applies the axial force promptly.

Next, the HSA 210 and other components are mounted in a clean room, then the printed board and other component are attached to the back surface of the housing 202, and the HDD 200 is completed (step 1500). The completed HDD 200 can guarantee high head positioning precision.

In operation of the HDD 200, a controller (not shown) of the HDD 200 drives the spindle motor 240 and rotates the discs 204. As discussed above, this embodiment reduces or eliminates the imbalance amount from the HDD 200, and maintains high rotating precision of the discs 204. The clamping force applied by the clamp ring 251 prevents the external impact from offsetting the disc 204, while maintaining a deformation amount of the disc 204. As a result, this embodiment can provide high head positioning precision.

The airflow associated with the rotation of the disc 204 is introduced between the disc 204 and slider, forming a minute air film and thus generating the floating force that enables the slider to float over the disc plane. The suspension 230 applies an elastic compression force to the slider against the floating force of the slider. The balance between the floating force and the elastic force separates the magnetic head part 220 from the disc 204 by a constant distance.

The controller (not shown) then controls the carriage 232 and rotates the carriage 232 around the shaft 234 for head's seek for a target track on the disc 204. In writing, the controller (not shown) receives, modulates, and amplifies data from a host such as a PC, supplies the inductive head with write current. Thereby, the inductive head device writes down the data onto the target track. In reading, the controller (not shown) selects the MR head device, and sends the predetermined sense current to the MR head. Thereby, the MR head reads desired information from the desired track on the disc 204.

Further, the present invention is not limited to these preferred embodiments, and various modifications and variations may be made without departing from the spirit and scope of the present invention. While this embodiment discusses the HDD, the present invention is applicable to another type of magnetic disc drive, such as a magneto optic disc drive.

What is claimed is:

1. A clamp device that clamps a disc onto a spindle motor that rotates the disc, said clamp device comprising:
a clamp ring stacked on the disc and clamps the disc onto the spindle motor;
a screw that fixes the clamp ring onto the spindle motor; and
an axial force adjuster that nonlinearly changes a relationship between a tightening force of the screw and an axial force actually applied to the disc, and includes an elastic part that has a spring constant smaller than that of said clamp ring.

2. A clamp device according to claim 1, wherein said axial force adjuster is provided between said clamp ring and the screw.

3. A clamp device according to claim 1, wherein said axial force adjuster has one or more holes each of which the screw is inserted.

4. A clamp device according to claim 1, wherein said axial force adjuster has an annular section.

5. A clamp device according to claim 1, wherein the elastic member is a base of said axial force adjuster, into which the screw is inserted.

6. A clamp device according to claim 1, wherein said axial force adjuster is provided to said clamp ring.

7. A storage comprising:
a spindle motor that rotates a disc; and
a clamp device that clamps the disc onto the spindle motor,
wherein said clamp device includes:
a clamp ring stacked on the disc and clamps the disc onto the spindle motor;
a screw that fixes the clamp ring onto the spindle motor; and
an axial force adjuster that nonlinearly changes a relationship between a tightening force of the screw and an axial force actually applied to the disc, and includes an elastic part that has a spring constant smaller than that of said clamp ring.

8. A clamp method that uses a clamp device to clamp a disc onto a spindle motor that rotates the disc, said clamp method comprising the steps of:
provisionally fixing the disc using the clamp device by setting to a first proportionality a relationship between a tightening force of the screw and an axial force actually applied to the disc in correcting a rotational balance of the disc; and
regularly fixing the disc using the clamp device by setting the relationship to a second proportionality that has a gradient greater than that of the first proportionality.
